(19) United States
(12) Patent Application Publication
(10) Pub. No.: US 2006/0021283 A1
(43) Pub. Date: Feb. 2, 2006

(54) Spring balance assembly

(76) Inventor: Steven E. Schultz, Rockford, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/172,454

(22) Filed: Jun. 30, 2005

Related U.S. Application Data
(60) Provisional application No. 60/584,579, filed on Jul. 1, 2004.

(51) Int. Cl. E05F 1/00

(52) U.S. Cl. 49/445

(57) ABSTRACT

The present invention provides a spring balance assembly for use with a sash window assembly slidable within a master frame. The spring balance assembly generally includes a plurality of stacked spring assemblies and pivot brake assembly. The spring assemblies include a coil spring and a support plate that rotatably supports the coil spring. Each coil spring has a free end, an intermediate portion, and a coiled portion, wherein the free ends are operably connected to the pivot brake assembly. The coil springs are configured to prevent a portion of the spring from excessive bowing and making prolonged contact with the wall of the mounting channel to which the balance assembly is affixed. In addition, the coil springs are wound in a manner that significantly reduces the occurrence of severe bowing of the coiled portion and engagement with the channel walls. The spring balance assembly of the present invention reduces contact with the channel walls and thereby reduces any friction and the operating force.

### CROSS-REFERENCE TO RELATED APPLICATIONS

This application claims the benefit of and priority from U.S. Provisional Application No. 60/584,579, filed Jul. 1, 2004, which application is incorporated herein by reference and made a part hereof.

### FEDERALLY SPONSORED RESEARCH OR DEVELOPMENT

Not applicable.

### TECHNICAL FIELD

The present invention relates to a spring balance assembly for a sash window. More specifically, the present invention relates to a spring balance assembly for use with a large sash window, wherein the balance assembly has at least one coil spring that is heat treated to resist operational deformation and thereby function as a constant force spring.

### BACKGROUND OF THE INVENTION

Sash windows disposed within a master frame are quite common. Generally, the master frame includes a pair of opposed vertical guide rails, an upper horizontal member or header, and a lower horizontal member or base. The guide rails are designed to slidingly guide at least one sash window within the master frame. For double hung sash windows, a common window configuration, the guide rails define an elongated channel. Within the industry, the channel width has been generally standardized to approximately 1.270 inches. To counterbalance the sash window during movement of the window, a spring balance assembly is affixed to the master frame in the elongated channel and is operably connected to the sash window. Conventional spring balance assemblies are generally positioned below the midpoint of the master frame to prevent interference with the hardware mounted to the sash window during the sliding movement of the sash window.

Typical spring balance assemblies include a mounting plate and number of coil springs wherein the springs collectively provide a counterbalancing force. In general terms, each coil spring includes a coiled portion, an intermediate portion and a free portion. The coiled portion is rotatably supported by a spindle extending from the plate, while the free portion is operably connected to a pivot brake assembly, which is coupled to a lower region of the sash window. The intermediate portion is the extent of the coil spring between the coiled portion and the free portion. Due to the dynamic operation of the coil spring, the precise dimensions of the intermediate portion varies as the sash window is raised and lowered.

Conventional spring balance assemblies used with large sash windows, including those exceeding six feet in height, are configured with at least two coil springs that are vertically stacked. Typically, a spring balance assembly is positioned on each side of the sash window. The stacked coil springs are designed to provide a sufficient counterbalancing force, such that the sash window can be raised and lowered. However, conventional balance assemblies are susceptible to deformation or bowing of the coil springs during operation. The deformation usually occurs when the coil spring is either fully elongated or just prior to full elongation. The deformation causes the intermediate portion to be displaced from its axis of operation, which is a substantially vertical axis within the mounting channel that aligns with the outer edge of the intermediate portion. When the intermediate portion deforms or deviates from the axis of operation, the coil spring further deviates from operating as a constant force spring. Described in a different manner, when not acting as a constant force spring, the intermediate portion is displaced transverse to the axis of operation. Thus, the intermediate portion moves generally within a central portion of the shoe channel. When the intermediate portion translates along the axis of operation, the coil spring is functioning similar to a constant force spring. This is preferable to ensure smooth operation of the sash window when it is raised and lowered.

Depending upon the severity of the deformation or deviation, the intermediate portion can make prolonged contact with the inner surface or wall of the mounting channel. Alternatively, the intermediate portion deviates inward beyond a mid-point or mid-axis of the mounting channel. In some situations, the intermediate portion can make repeated or prolonged contact with the mounting channel. In these instances, the coil spring is not acting as a constant force spring. The engagement between the intermediate portion and the mounting channel results in noise and increased friction therebetween. The friction between the intermediate portion and the mounting channel significantly increases the operating force necessary to raise and/or lower the sash window. Also, the resultant friction can hinder operational performance of the sash window and the spring balance assembly. Furthermore, the deviation from the axis of operation can cause the pivot brake assembly to make repeated or prolonged contact with the mounting channel. The engagement between the pivot brake assembly and the channel results in additional noise and increased friction therebetween. Like the friction between the intermediate portion and the mounting channel, the friction between the pivot brake assembly and the channel increases the operating force necessary to raise and/or lower the sash window. Conventional large window assemblies require an operating force that ranges between 45 and 65 pounds. This range is negatively affected by the build-up of friction within the mounting channel.

When the engagement between the intermediate portion and the channel is prolonged, an extent of the coiled portion becomes uncoiled and makes contact with an opposite wall of the mounting channel. In this manner, the outer diameter of the coiled portion increases or grows whereby the uncoiled extent makes contact with the channel. The amount of contact between the mounting channel and the uncoiled extent can vary with the degree of winding of the coiled portion. For example, the contact can increase when the coiled portion is tightly wound about the spindle of the support plate. Similar to the engagement between the intermediate portion and the channel wall, the engagement between the uncoiled extent and the opposite wall of the channel results in noise and increased friction therebetween. The friction between the uncoiled extent and the channel wall increases the force necessary to raise and/or lower the sash window.

As explained above, there can a plurality of wall strikes within the channel by the spring balance assembly. For example, a first strike occurs when the intermediate portion makes contact with the channel wall, a second strike occurs when the pivot brake assembly makes contact with the channel wall, and a third strike occurs when the uncoiled extent, e.g., the portion immediately extending from the coiled portion, makes contact with the channel wall. When the wall strikes are prolonged, the friction between the coil spring and the channel wall increases and the coil spring does not function as a constant force spring, which increases the force required to raise or lower the window. In some situations, the number of wall strikes increases if an operator abruptly attempts to raise and/or lower the sash window.

The present invention is provided to solve the problems discussed above and other problems, and to provide advantages and aspects not provided by prior spring balance assemblies. A full discussion of the features and advantages of the present invention is deferred to the following detailed description, which proceeds with reference to the accompanying drawings.

### SUMMARY OF THE INVENTION

The present invention relates to a spring balance assembly for use with a sash window assembly. The spring balance assembly includes at least one coil spring that has been heat treated, primarily stress relieved to reduce residual stresses, to provide for constant force behavior. In one preferred embodiment, the spring balance assembly is used in connection with a large sash window assembly, e.g. exceeding thirty pounds. According to a first aspect of the invention, the spring balance assembly is mounted within a channel of the window assembly. The spring balance assembly includes at least one constant force coil spring. As an example, the balance assembly includes a first coil spring assembly having a coil spring rotatably supported by a plate, the coil spring having an intermediate portion and a free portion that is connected to a brake shoe assembly; a second coil spring assembly having a coil spring rotatably supported by a plate, the coil spring having an intermediate portion and a free portion that is connected to the brake shoe assembly; a third coil spring assembly having a coil spring rotatably supported by a plate, the coil spring having an intermediate portion and a free portion that is connected to the brake shoe assembly; and, a fourth coil spring assembly having a coil spring rotatably supported by a plate, the coil spring having an intermediate portion and a free portion that is connected to the brake shoe assembly. Furthermore, the intermediate portion of the first, second, third and fourth coil springs are positioned along a common axis of operation when the four coil springs are in an extended position. Preferably, the axis of operation is oriented vertically within the mounting channel.

According to another aspect of the invention, the positioning of the intermediate portion of the coil spring along the axis of operation reduces an operating force required to move the sash window between an open position and a closed position. When the intermediate portion remains positioned along the axis of operation, the coil spring does not make contact, either intermittent or continuous, with an inner wall(s) of the channel when the four coil springs are in the extended position or elongated under load. A clearance exists between the intermediate portion and the inner walls when the coil spring is positioned substantially along the axis of operation.

According to another aspect of the invention and in the multiple coil spring configuration, the free portion of the third coil spring can be operably coupled to the free portion of the first coil spring. Similarly, the free portion of the fourth coil spring can be operably coupled to the free portion of the second coil spring. In this configuration, the intermediate portions of the first and third springs are positioned along a first axis of operation and the intermediate portions of the second and fourth springs are positioned along a second axis of operation, the axis being spaced from each other and substantially parallel. Furthermore, the spring balance assembly is mounted within the channel such that a coiled portion of each spring does not make prolonged contact with the inner walls when the coil springs are in the extended position.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1A is a front elevation view of a spring balance assembly mounted to a sash window assembly wherein the window assembly is shown in a closed position;

FIG. 1B is a front elevation view of the spring balance assembly mounted to a sash window assembly wherein the window assembly is shown in an open position;

FIG. 2 is a perspective view of a spring balance assembly of the invention showing a plurality of coil spring assemblies and a balance shoe assembly extending from a mounting channel;

FIG. 3 is an elevated end view of the spring balance assembly and the mounting channel;

FIG. 4 is a plan view of the spring balance assembly and the mounting channel;

FIG. 5A is a perspective view of coil springs of a conventional spring balance assembly, showing the intermediate portion of the springs positioned a distance from the axis of operation;

FIG. 5B is a perspective view of coil springs of a conventional spring balance assembly, showing the intermediate portion of the springs positioned a distance from the axis of operation; and,

FIG. 6 is a perspective view of coil springs of the spring balance assembly, showing the intermediate portion of the springs positioned along the axis of operation.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

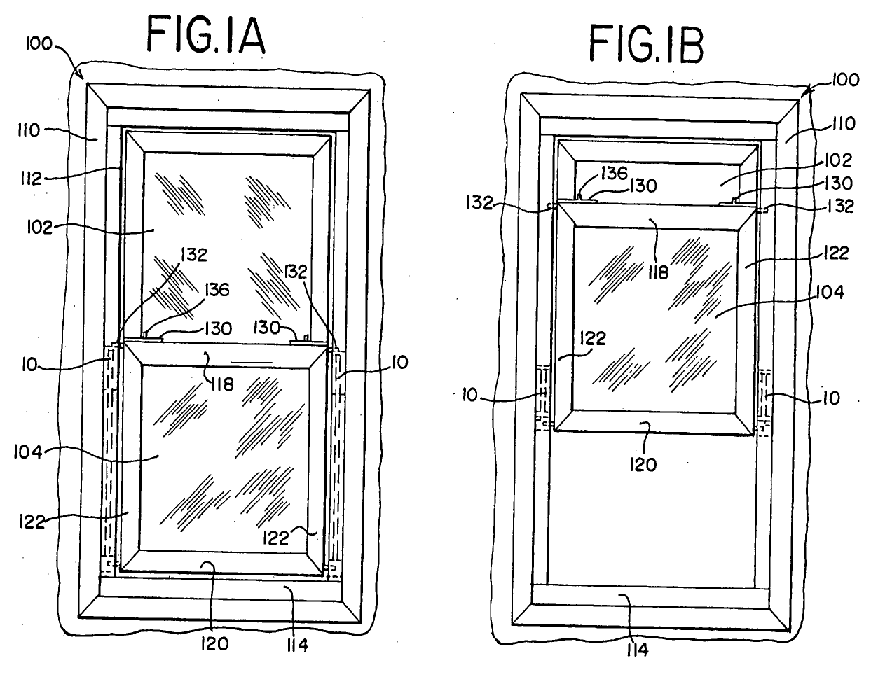

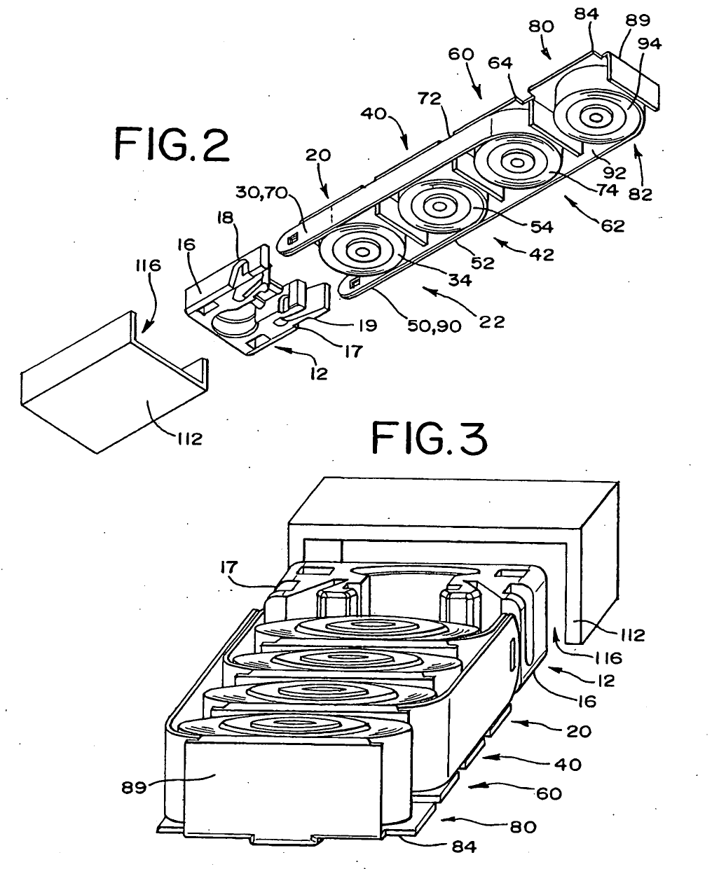

Referring to FIGS. 1A, 1B and 2, a spring balance assembly 10 is affixed to a sash window assembly 100. The spring balance assembly 10 includes at least one coil spring that has been heat treated, primarily stress relieved for reduce residual stress reduction, to provide for constant force behavior. One of skill in the art understands that a constant force coil spring has a constant restoring force, regardless of its displacement or elongation. When the spring balance assembly 10 is installed as shown in FIGS. 1A and 1B and the constant force coil spring is elongated in a downward direction (towards the footer 14), the restoring force is directed upward and opposite the elongation force. A constant force spring is preferred because a free end and the intermediate portion will resist bowing or deviation when the spring is extended. With a coil spring that is not a constant force spring, the restoring force is directed at an angle to or transverse to the direction of elongation, thereby causing bowing. As explained below, the coil spring of the present invention is heated to a temperature range consistent with the stress relieving aspect of heat treatment to achieve true constant force behavior.

The sash window assembly 100 shown in FIGS. 1A and B is a large double-hung window assembly having an upper pivotal sash window 102 and a lower pivotal sash window 104 in a master frame 110. In general terms, the master frame 110 includes a pair of opposed vertical guide rails 112 adapted to slidably guide the sash windows 102, 104. The master frame further includes a footer or lower horizontal element 114. The guide rail 112 defines an elongated channel 116 in which the spring balance assembly 10 is mounted. The channel 116 may also be referred to as a shoe channel 116. In one application, the industry has arrived at a standard width for the channel 116 of approximately 1.270 inches. As a result, the spring balance assembly 10 is configured to fit therein. Typically, the master frame 110 has a set of guide rails 112 for each sash window 102, 104 and the balance assembly 10 is mounted to each guide rail 112 to balance the sash window 102, 104. The sash window 104 has a top rail 118, a base rail 120, and a pair of stiles or side rails 122. A tilt latch 130 is mounted in an upper portion of the top rail 118. The tilt latch 130 has a bolt 132 with a nose portion adapted to extend into the elongated channel 116. The tilt latch 130 has an actuator 136 and a spring (not shown) wherein the actuator 136 is designed to retract the bolt 132 into the housing of the latch 130 against the biasing force of the spring.

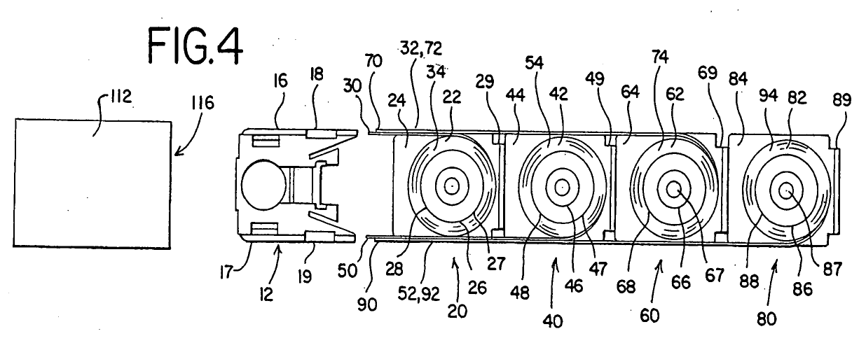

As shown in FIGS. 2-4, the spring balance assembly 10 generally includes a first spring assembly 20, a second spring assembly 40, a third spring assembly 60 and a fourth spring assembly 80. As explained below, the spring assemblies 20, 40, 60, 80 are operably connected to a shoe or pivot brake assembly 12. The springs within the spring balance assembly 10 are heat treated to function as a constant force spring to either eliminate or minimize the frictional buildup between the mounting channel 116 and certain assembly 10 components, thereby reducing the operating force required by a large sash window assembly 100. Preferably, the spring assemblies 20, 40, 60, 80 are aligned or stacked in a substantially vertical position within the channel 116. Although the balance assembly 10 is shown to have four distinct spring assemblies 20, 40, 60, 80, in another embodiment, the balance assembly 10 can include a greater or lesser number of spring assemblies. For example, the spring balance assembly 10 can include a single coil spring assembly 20 that has undergone stress release heat treatment.

Each spring assembly 20, 40, 60, 80 includes a coil spring 22, 42, 62, 82 and a support plate 24, 44, 64, 84 that rotatably supports the coil spring 22, 42, 62, 82. A generally cylindrical spindle 26, 46, 66, 86 extends from each support plate 24, 44, 64, 84, wherein the spring 22, 42, 62, 82 is rotatably mounted on the spindle 26, 46, 66, 86. Each spindle 26, 46, 66, 86 has a central opening 27, 47, 67, 87 that is configured to receive a fastener (not shown) to secure the spring balance assembly 10 within the mounting channel 116 to the guide rail 112. The spring assembly 20, 40, 60, 80 also includes a drum 28, 48, 68, 88 positioned between the coil spring 22, 42, 62, 82 and the spindle 26, 46, 66, 86 to aid in the rotation of the spring 22, 42, 62, 82. Each support plate 24, 44, 64, 84 includes a top wall 29, 49, 69, 89 that extends substantially transverse to the plate 24, 44, 64, 84. When the spring assemblies 20, 40, 60, 80 are stacked as shown in FIGS. 1-3, the three top walls 29, 49, 69, act as a partition wall. The coil spring 22, 42, 62, 82 can be formed from a variety of metals, including stainless steel. In one embodiment, 301 stainless steel is used to fabricate the coil spring 22, 42, 62, 82.

Referring to FIGS. 2-4, each coil spring 22, 42, 62, 82 has a free end 30, 50, 70, 90, an intermediate portion 32, 52, 72, 92, and a coiled portion 34, 54, 74, 94. The coiled portion 34, 54, 74, 94 forms a spool which is rotatably supported by the spindle 26, 46, 66, 86. One of skill in the art recognizes that the length of the intermediate portion 32, 52, 72, 92 will vary as the spring 22, 42, 62, 82 elongates and returns. The coiled portion 34, 54, 74, 94 has a terminal end positioned within the spool and against an outer portion of the spindle 26, 46, 66, 86. The free ends 30, 70 of the first and third coil springs 22, 62 are coupled and then operably connected to the pivot brake assembly 12. Similarly, the free ends 50, 90 of the second and fourth coil springs 42, 82 are coupled and then operably connected to the pivot brake assembly 12. Although not shown, the free ends 30, 50, 70, 90 can be connected to the brake assembly 12 with a threaded fastener or a similar fastening means. Alternatively, the free ends 30, 50, 70, 90 are each connected to the pivot brake assembly 12. Referring to FIG. 2, the first and third springs 22, 62 have a left-hand orientation, meaning that their free ends 30, 70 extend along the left side of the spring balance assembly 10. In contrast, the second and fourth springs 42, 82 have a right-hand orientation, meaning that their free ends 50, 90 extend along the right side of the spring balance assembly 10. In this manner, the spring assemblies 20, 40, 60, 80 have a staggered or alternating configuration with respect to the intermediate portions 32, 52, 72, 92 and the free ends 30, 50, 70, 90.

In addition to being connected to the coil springs 22, 42, 62, 82, the pivot brake assembly 12, or sash shoe, is operably connected to a lower portion of the sash window 104 near the base rail 120. When the pivot brake assembly 12 is coupled to the sash window 104, the spring balance assembly 10 counterbalances the weight of the sash window 104 wherein the coil springs 22, 42, 62, 82 collectively exert a generally upward force on the sash window 104 when it is moved between the closed and open positions of FIGS. 1A and B. The pivot brake assembly 12 generally includes a central cam (not shown) and a housing 14, which is defined, in part, by opposed side walls 16, 17. In one embodiment, the free ends 30, 70 are received in a slot 18 near the first side wall 16 and secured therein, and the free ends 50, 90 are received in a slot 19 near the second side wall 17 and secured therein.

Referring to FIGS. 2-4, the coil springs 22, 42, 62, 82 have an inner diameter of approximately 0.790 inch and an outer diameter of approximately 1.120 inches, with a 0.005 tolerance. In addition, the coil springs 22, 42, 62, 82 have a nominal thickness of approximately 0.013 inch with a 0.0005 tolerance. These dimensions represent a departure from conventional coil springs, especially that of the outer diameter and the thickness. The dimensions of the coil springs 22, 42, 62, 82 are specifically selected to provide an operating life of roughly 4,000 cycles of sash window 102, 104 operation. The outer dimension of the coil springs 22, 42, 62, 82 help to prevent the coiled portions 34, 54, 74, 94 from increasing or growing whereby an extent becomes uncoiled. An uncoiled extent of the coiled portions 34, 54, 74, 94 can make limited contact with one of the inner walls of the mounting channel 116, which increases the friction therebetween and increases the operational force need to raise and/or lower the sash window 104.

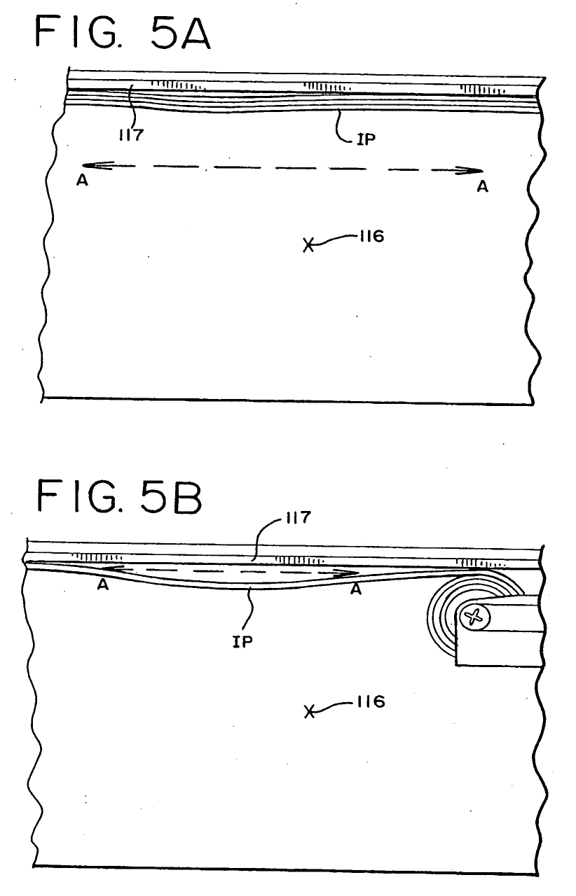

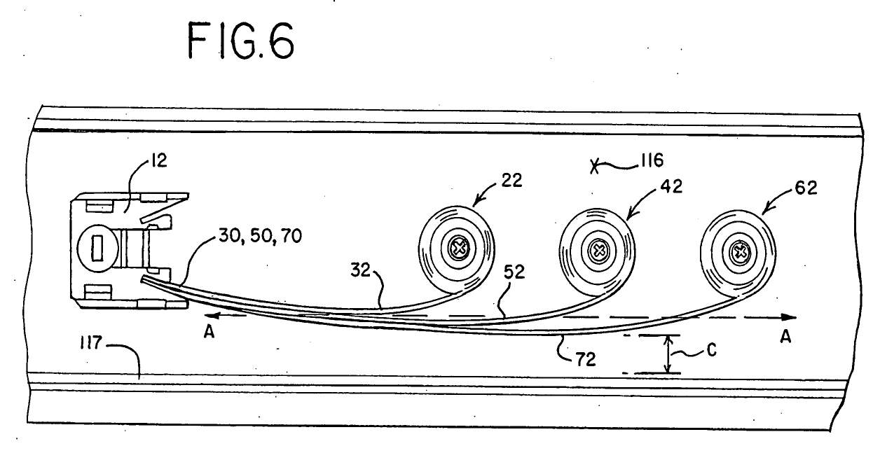

Conventional coil springs are annealed, which causes the spring to not function as a constant force spring, further resulting in the uncoiled or intermediate portion of the spring bowing or flaring outward (see FIGS. 5A and B) towards the inner walls of the mounting channel 116. Alternatively, the intermediate portion of the spring bows inward, meaning towards a central region of the mounting channel 116. The coil springs 22, 42, 62, 82 of the present invention are heat treated and wound in a manner that significantly reduces the occurrence of bowing or flaring. As shown in FIG. 5A, the intermediate portions IP of conventional coil springs are significantly bowed or displaced past the axis of operation A-A and towards the wall 117 of the mounting channel 116. The displacement is so pronounced that the intermediate portion IP makes contact with the wall 117 which results in increased friction therebetween. Referring to FIG. 5B, the intermediate portion IP of another conventional coil spring is bowed or displaced inward of the axis of operation A-A and towards the central region of the mounting channel 116. In contrast and as shown in FIG. 6, the intermediate portions 32, 52, 72 of the coil springs 22, 42, 62, of the spring balance assembly 10 are substantially aligned with the axis of operation A-A. As a result, the coil springs 22, 42, 62, 82 are less likely to make prolonged contact with the inner wall 117 of the mounting channel 116. The alignment between the intermediate portions 32, 52, 72 and the axis of operation A-A helps to prevent engagement between the brake shoe 12 and the inner wall 117, which often occurs with conventional designs. Furthermore, there is a clearance C between the inner wall 117 of the channel 116 and the intermediate portions 32, 52, 72. In comparison, there is no corresponding clearance for the conventional coil spring depicted in FIG. 5. In the event that the first free end 30 is secured to a first side of the brake shoe assembly 12 and the second free end 50 is secured to a second side of the brake shoe assembly 12, then there are two generally parallel axes of operation A-A. The axes of operation A-A are separated a distance that slightly exceeds the width of either the support plate or the coiled portion of the springs 22, 42.

To achieve constant force behavior and provide movement along the axis of operation, the coil springs 22, 42, 62, 82 undergo stress release heat treatment, which involves exposure to an elevated temperature for an extended time period and then slow cooling. The three general stages of stress relief—heating to the desired temperature, holding at that temperature, and cooling—are carefully applied to the coil springs 22, 42, 62, 82 such that the spring functions as a constant force spring. In comparison to annealing, which involves heating the coil spring to at least 1800° F., stress release involves heating the coil spring to only 450-550° F. The benefits of stress release heat treatment of the coil springs 22, 42, 62, 82 include relieving internal stress, increasing ductility and toughness, and/or producing a specific microstructure. Conventional coil springs are annealed; however, the high temperatures associated with annealing overheats the material and prevents the coil spring from operating as a constant force spring. Although the spring balance assembly 10 may contain a number of springs, the heat treatment is discussed with respect to a single coil spring 22. To achieve the stress relief necessary for the coil spring 22 to function as a constant force spring, the spring 22 is heated to a temperature range of 450-550° F., with 500° F. being a most preferred temperature. This heating temperature is far lower than the corresponding temperature ranges of 1800-1950° F. for conventional annealing. Once the spring 22 reaches the desired temperature range, it is heated for approximately 30-45 minutes. After that time period, the spring 22 is cooled to room temperature under ambient conditions or with a forced air device, e.g., blower. Compared to conventional annealing, which can negate the effects of cold work on the spring 22, the relatively low temperature range used with the invented stress release does not affect the effects of cold work on the spring 20.

In operation, the spring balance assembly 10 provides an operating force for the large sash assembly 100 that is considerably less than conventional balance assemblies. The spring balance assembly 10 is able to provide such benefit because the coil springs 22, 42, 62, 82 are carefully designed and heat treated to reduce and/or eliminate friction between the intermediate spring portion 32, 52, 72, 92 and the mounting channel 116 during movement of the windows 102, 104. As explained above, the coiled springs 22, 42, 62, 82, including the intermediate portions 32, 52, 72, 92, resist severe bowing and translate substantially along the axis of operation A-A, which precludes extended contact with the internal walls 117 of the channel 116. This represents a significant improvement over conventional devices since friction is eliminated, the operational force is reduced, and attendant noise is lessened.

The data provided in the following tables relates to coil springs utilized in the spring balance assembly 10 of the present invention. For the various part numbers listed in the tables, certain measurements, including the inner diameter, outer diameter, load, and thickness, are recorded for analysis. In general terms, the data shows that the coil springs 22, 42, 62, 82 provide a sufficient operating force for use with large sash window assemblies 100 while addressing the bowing and frictional issues discussed herein.

Existing spring balance assemblies used with large sash window assemblies feature thick, annealed coil springs. Conventional wisdom has led designers to conclude that annealing thick coil springs is required to counterbalance such heavy window assemblies. Also contrary to conventional wisdom, these springs do not function as constant force springs and cause undue bowing and frictional engagement with the channel wall. The friction causes higher operational forces to lower and raise the large windows. According to the present invention, the coil springs 22, 42, 62, 82 are thinner and heat treated to function as constant force springs. As a result, the coil springs 22, 42, 62, 82 operate more smoothly, do not bow as much as prior art coil springs, and translate substantially along the axis of operation A-A while maintaining a substantially vertical orientation. The coil springs 22, 42, 62, 82 do not continuously engage the side walls of the mounting channel 116 with a binding force and do not impart undue force on the brake shoe assembly 12. Accordingly, the spring balance assembly 10 requires less operating force for operation of a large, heavy sash window.

While the specific embodiments have been illustrated and described, numerous modifications come to mind without significantly departing from the spirit of the invention, and the scope of protection is only limited by the scope of the accompanying claims.

Data for Heat Treaded Coiled Springs
Coiled Spring Test Data

| | | | | | | |
|---|---|---|---|---|---|---|
| 1 | 2 | 3 | 4 | 5 | 6 | Avg. |

Part A

| | | | | | | | |
|---|---|---|---|---|---|---|---|
| ID | 0.742 | 0.746 | 0.746 | 0.748 | 0.746 | 0.748 | 0.746 |
| OD | 1.105 | 1.101 | 1.102 | 1.104 | 1.104 | 1.104 | 1.103 |
| Length | 40.00 | 40.00 | 40.00 | 40.00 | 40.00 | 40.00 | 40.00 |
| Pickup | 1.12 | 1.12 | 1.12 | 1.120 | 1.12 | 1.12 | 1.120 |
| Drum Size | 0.620 | 0.620 | 0.620 | 0.620 | 0.620 | 0.620 | 0.620 |
| Load @ 2″ | 4.4 | 4.4 | 4.3 | 4.2 | 4.5 | 4.3 | 4.3 |
| Load @ 34″ | 6.0 | 5.8 | 5.85 | 6.0 | 5.85 | 6.1 | 5.9 |
| Thickness | 0.0130 | 0.0131 | 0.0131 | 0.0130 | 0.0130 | 0.0130 | 0.0130 |

Part B

| | | | | | | | |
|---|---|---|---|---|---|---|---|
| ID | 0.743 | 0.744 | 0.742 | 0.743 | 0.748 | 0.746 | 0.744 |
| OD | 1.109 | 1.112 | 1.108 | 1.11 | 1.112 | 1.113 | 1.111 |
| Length | 41.50 | 41.50 | 41.50 | 41.50 | 41.50 | 41.50 | 41.50 |
| Pickup | 2.750 | 2.750 | 2.750 | 2.750 | 2.750 | 2.750 | 2.750 |
| Drum Size | 0.620 | 0.620 | 0.620 | 0.620 | 0.620 | 0.620 | 0.620 |
| Load @ 2″ | 4.1 | 4.1 | 4.2 | 4.2 | 4.4 | 4.2 | 4.2 |
| Load @ 34″ | 5.8 | 5.8 | 5.9 | 5.8 | 5.8 | 5.8 | 5.8 |
| Thickness | 0.0131 | 0.0131 | 0.0131 | 0.0131 | 0.0131 | 0.0131 | 0.0131 |

Part C

| | | | | | | | |
|---|---|---|---|---|---|---|---|
| ID | 0.741 | 0.744 | 0.743 | 0.741 | 0.740 | 0.745 | 0.742 |
| OD | 1.1 | 1.100 | 1.100 | 1.106 | 1.108 | 1.115 | 1.105 |
| Length | 43.00 | 43.00 | 43.00 | 43.00 | 43.00 | 43.00 | 43.00 |
| Pickup | 3.250 | 3.250 | 3.250 | 3.250 | 3.250 | 3.250 | 3.250 |
| Drum Size | 0.620 | 0.620 | 0.620 | 0.620 | 0.620 | 0.620 | 0.620 |
| Load @ 2″ | 4.5 | 4.5 | 4.4 | 4.4 | 4.4 | 4.4 | 4.4 |
| Load @ 34″ | 5.6 | 5.8 | 5.8 | 5.9 | 5.8 | 5.8 | 5.775 |
| Thickness | 0.0130 | 0.0132 | 0.0131 | 0.0130 | 0.0131 | 0.0132 | 0.013 |

Part D

| | | | | | | | |
|---|---|---|---|---|---|---|---|
| ID | 0.747 | 0.745 | 0.749 | 0.746 | 0.749 | 0.746 | 0.747 |
| OD | 1.117 | 1.117 | 1.124 | 1.119 | 1.12 | 1.117 | 1.12 |
| Length | 44.50 | 44.50 | 44.50 | 44.50 | 44.50 | 44.50 | 44.50 |
| Pickup | 5.250 | 5.250 | 5.250 | 5.250 | 5.250 | 5.250 | 5.25 |
| Drum Size | 0.620 | 0.620 | 0.620 | 0.620 | 0.620 | 0.620 | 0.620 |
| Load @ 2″ | 4.7 | 4.6 | 4.5 | 4.5 | 4.45 | 4.5 | 4.5 |
| Load @ 34″ | 5.6 | 5.8 | 5.8 | 5.9 | 5.8 | 5.8 | 5.8 |
| Thickness | 0.0129 | 0.0132 | 0.01305 | 0.0130 | 0.0131 | 0.0132 | 0.0131 |

| | | | |
|---|---|---|---|
| 1 | 2 | 3 | Avg. |

Part E

| | | | | |
|---|---|---|---|---|
| ID | 0.735 | 0.743 | 0.748 | 0.742 |
| OD | 1.124 | 1.124 | 1.130 | 1.126 |
| Length | 40.07 | 40.07 | 40.07 | 40.07 |
| Pickup | 1.061 | 1.044 | 1.008 | 1.038 |
| Drum Size | 0.503 | 0.503 | 0.503 | 0.503 |
| Load @ 2″ | 5.0 | 5.1 | 5.1 | 5.1 |
| Load @ 34″ | 5.9 | 6.1 | 6.2 | 6.1 |

Part F

| | | | | |
|---|---|---|---|---|
| ID | 0.740 | 0.733 | 0.744 | 0.739 |
| OD | 1.127 | 1.120 | 1.127 | 1.125 |
| Length | 40.07 | 40.07 | 40.07 | 40.07 |
| Pickup | 1.046 | 1.040 | 1.044 | 1.043 |
| Drum Size | 0.503 | 0.503 | 0.503 | 0.503 |
| Load @ 2″ | 5.2 | 5.3 | 5.2 | 5.2 |
| Load @ 34″ | 6.5 | 6.5 | 6.5 | 6.5 |

Part G

| | | | | |
|---|---|---|---|---|
| ID | 0.749 | 0.744 | 0.742 | 0.745 |
| OD | 1.122 | 1.119 | 1.120 | 1.120 |
| Length | 41.53 | 41.53 | 41.53 | 41.53 |
| Pickup | 2.450 | 2.491 | 2.500 | 2.480 |
| Drum Size | 0.503 | 0.503 | 0.503 | 0.503 |
| Load @ 2″ | 5.1 | 5.2 | 5.3 | 5.2 |
| Load @ 34″ | 6.3 | 6.3 | 6.3 | 6.3 |

Part H

| | | | | |
|---|---|---|---|---|
| ID | 0.751 | 0.748 | 0.747 | 0.749 |
| OD | 1.118 | 1.119 | 1.121 | 1.119 |
| Length | 41.53 | 41.53 | 41.53 | 41.53 |
| Pickup | 2.451 | 2.520 | 2.514 | 2.495 |
| Drum Size | 0.503 | 0.503 | 0.503 | 0.503 |
| Load @ 2″ | 5.5 | 5.4 | 5.4 | 5.4 |
| Load @ 34″ | 6.6 | 6.5 | 6.7 | 6.6 |

Part I

| | | | | |
|---|---|---|---|---|
| ID | 0.751 | 0.746 | 0.745 | 0.747 |
| OD | 1.128 | 1.122 | 1.120 | 1.123 |
| Length | 43.051 | 43.051 | 43.051 | 43.051 |
| Pickup | 3.784 | 3.713 | 3.774 | 3.757 |
| Drum Size | 0.503 | 0.503 | 0.503 | 0.503 |
| Load @ 2″ | 5.2 | 4.6 | 4.6 | 4.8 |
| Load @ 34″ | 6.4 | 6.2 | 6.3 | 6.3 |

Part J

| | | | | |
|---|---|---|---|---|
| ID | 0.746 | 0.748 | 0.743 | 0.746 |
| OD | 1.121 | 1.121 | 1.123 | 1.122 |
| Length | 43.051 | 43.051 | 43.051 | 43.051 |
| Pickup | 3.752 | 3.777 | 3.825 | 3.785 |
| Drum Size | 0.503 | 0.503 | 0.503 | 0.503 |
| Load @ 2″ | 5.5 | 5.4 | 5.4 | 5.4 |
| Load @ 34″ | 6.6 | 6.6 | 6.7 | 6.6 |

Part K

| | | | | |
|---|---|---|---|---|
| ID | 0.758 | 0.748 | 0.752 | 0.753 |
| OD | 1.125 | 1.128 | 1.125 | 1.126 |
| Length | 44.61 | 44.61 | 44.61 | 44.61 |
| Pickup | 5.080 | 5.070 | 5.070 | 5.073 |
| Drum Size | 0.503 | 0.503 | 0.503 | 0.503 |

Part L

| | | | | |
|---|---|---|---|---|
| ID | 0.767 | 0.746 | 0.760 | 0.758 |
| OD | 1.130 | 1.120 | 1.127 | 1.126 |
| Length | 44.61 | 44.61 | 44.61 | 44.61 |
| Pickup | 5.126 | 5.116 | 5.125 | 5.122 |
| Drum Size | 0.503 | 0.503 | 0.503 | 0.503 |

What is claimed is:

1. A spring balance assembly for a sash window slidable within a master frame, the master frame having a channel, the spring balance assembly mounted within the channel and having a brake shoe assembly, the spring balance assembly comprising:
a first coil spring having an intermediate portion and a free end that is configured to be connected to the brake shoe assembly, the intermediate portion extending along a first axis of operation when the spring is elongated, the first axis extending vertically within the master frame channel; and,
wherein the first coil spring is heat treated to prevent the intermediate portion from deviating from the first axis of operation when the spring is elongated.

2. The spring balance assembly of claim 1 further comprising a second coil spring having an intermediate portion and a free end that is configured to be connected to the brake shoe assembly, the intermediate portion extending along a second axis of operation when the spring is elongated, and wherein the second coil spring is heat treated to prevent the intermediate portion from deviating from the second axis of operation when the spring is elongated.

3. The spring balance assembly of claim 2 further comprising a brake shoe assembly, wherein the free end of the first spring is connected to a first wall of the brake shoe assembly and the free end of the second spring is connected to a second wall of the brake shoe assembly.

4. The spring balance assembly of claim 1 wherein the heat treatment occurs after the coil spring is wound.

5. The spring balance assembly of claim 1 wherein the heat treatment involves heating the coil spring to a temperature range of 450-550 degrees Fahrenheit for approximately 30-45 minutes.

6. The spring balance assembly of claim 5 wherein the heat treatment occurs at 500 degrees Fahrenheit.

7. The spring balance assembly of claim 2 wherein the coil springs are fabricated from stainless steel.

8. The spring balance assembly of claim 2 wherein each coil spring is a constant force spring.

9. The spring balance assembly of claim 1 wherein the coil spring has a length ranging from 40.044.5 inches and a thickness of less than 0.0135 inch.

10. A spring balance assembly for a large sash window slidable within a master frame, the master frame having a channel, the spring balance assembly mounted within the channel and comprising:
a support plate;
a constant force first coil spring rotatably supported by the plate, the coil spring having an intermediate portion and a free end that is connected to a first portion of a brake shoe assembly;
a constant force second coil spring rotatably supported by the plate, the coil spring having an intermediate portion and a free end that is connected to a second portion of brake shoe assembly;
a constant force third coil spring rotatably supported by the plate, the coil spring having an intermediate portion and a free end that is operably coupled to the free end of the first coil spring;
wherein the intermediate portion of the first and second springs extend along a first axis of operation and the intermediate portion of the second spring extends along a second axis of operation, the first and second axes of operation extending vertically within the master frame channel; and,
wherein the first, second and third coil springs undergo stress relief heat treatment to ensure that the intermediate portion of each spring extends along the respective axis of operation when the spring is elongated.

11. The spring balance assembly of claim 10 wherein the first and second axes of operation are parallel.

12. The spring balance assembly of claim 11 wherein the first and second axes of operation are spaced a distance greater than a width of the plate.

13. The spring balance assembly of claim 10 wherein the first spring free end is received in a first slot of the brake shoe assembly.

14. The spring balance assembly of claim 13 wherein the second spring free end is received in a second slot of the brake shoe assembly, the first and second slots being located in opposite side of the brake shoe assembly.

15. The spring balance assembly of claim 10 wherein the first spring has a slot that receives the third free end to operably connect the first and third springs.

16. The spring balance assembly of claim 10 wherein each spring has a thickness of approximately 0.013 inch.

17. The spring balance assembly of claim 10 wherein the stress relief heat treatment involves heating each coil spring to a temperature range of 450-550 degrees Fahrenheit for approximately 30-45 minutes.

18. The spring balance assembly of claim 17 wherein the heat treatment occurs at 500 degrees Fahrenheit.

19. The spring balance assembly of claim 17 wherein the stress relief heat treatment further involves cooling each coil spring to a room temperature.

20. A spring balance assembly for a large sash window slidable within a master frame, the master frame having a channel, the spring balance assembly mounted within the channel and comprising:
a first constant force coil spring having an intermediate portion and a free end that is connected to a first portion of a brake shoe assembly, wherein the intermediate portion extends along an axis of operation when the spring is elongated and the axis extends vertically within the channel;
a second constant force coil spring having an intermediate portion and a free end that is connected to the first brake shoe portion, wherein the intermediate portion extends along the axis of operation when the spring is elongated;
wherein the first and second coil springs undergo stress relief to prevent the intermediate portions from deviating from the axis during operation and to ensure constant force behavior.

21. The spring balance assembly of claim 20 wherein the first and second constant force coil springs are operably connected to a support plate.

22. The spring balance assembly of claim 20 wherein each coil spring is heated to a temperature of approximately 500 degrees Fahrenheit to provide stress relief.

23. The spring balance assembly of claim 22 wherein the heating of each coil spring occurs for between 30 and 45 minutes.
